(19) United States
(12) Patent Application Publication
(10) Pub. No.: US 2003/0113103 A1
(43) Pub. Date: Jun. 19, 2003

(54) Image recording apparatus

(75) Inventor: Junya Kaku, Hyogo (JP)

Correspondence Address: ARMSTRONG,WESTERMAN & HATTORI, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/318,202

(22) Filed: Dec. 13, 2002

(30) Foreign Application Priority Data
Dec. 17, 2001 (JP) 2001-383528

(51) Int. Cl. H04N 5/781

(52) U.S. Cl. 386/95; 386/111; 386/125

(57) ABSTRACT

An image recording apparatus includes a CPU. The CPU, when recording a plurality of frames of JPEG data onto a magneto optical disk, calculates a difference between a remainder acquired by dividing a JPEG data size of each frame by a cluster size and the cluster size. The JPEG data is recorded on a data area of the magneto optical disk in a state pad data with a size corresponding to the calculated difference is added to an end. A head address of each frame of the JPEG data coincides with a head address of a cluster. Management information individually managing the JPEG data of each frame is recorded on the data area and an FAT area on the magneto optical disk.

### BACKGROUND OF THE INVENTION

1. Field of the Invention

The present invention relates to an image recording apparatus applied to a digital camera, for example. More specifically, the present invention relates to an image recording apparatus for recording a plurality of still image signals onto a plurality of unit areas which is formed on a recording medium and each of which has a predetermined size.

2. Description of the Prior Art

In a digital camera, when a successive photographing mode (successive shooting mode) is selected, an object is photographed every 1/15 seconds, and photographed image signals are stored in a buffer memory. After completion of photographing a predetermined number of times, a recording process is performed on the plurality of image signals stored in the buffer memory. More specifically, a plurality of image files respectively including the plurality of image signals are formed on a data area of the recording medium, and file management information respectively managing the plurality of image files is written to a management area of the recording medium.

However, during a recording operation, it is forbidden to newly write an image signal to a buffer memory. In a case the recording medium is a disk recording medium such as a magneto optical disk, there is a case that it takes two seconds every time a recording process of one image signal is performed. Thereupon, in a case the number of successive photographing times is forty, it takes about eighty seconds from reservation of forty image signals in the buffer memory to next photographing.

It is noted that a creating process of the file management information takes the longest time in the recording process. This is because the data area and the file management area are separately formed, and therefore, head seek is required from the data area to the file management area.

### SUMMARY OF THE INVENTION

Therefore, it is a primary object of the present invention to provide an image recording apparatus capable of shortening a time required to record successively photographed image signals.

According to the present invention, an image recording apparatus for recording a plurality of still image signals on a plurality of unit areas which are formed on a recording medium and each of which has a predetermined size, comprises: a calculator for calculating as to each of the plurality of still image signals a difference between the predetermined size and a remainder obtained by dividing a signal size by the predetermined size; an image recorder for recording the plurality of still image signals on the recording medium in a state a dummy signal whose size is equal to the difference is added to an end of each of the plurality of still image signals; and a first management information recorder for recording on the recording medium first management information for individually managing the plurality of still image signals.

The plurality of unit areas each of which has a predetermined size are formed on the recording medium, and the plurality of still image signals are recorded on such the unit areas. Herein, the calculator calculates as to each of the plurality of still image signals the difference between the predetermined size and the remainder obtained by dividing the signal size by the predetermined size. The plurality of still image signals are recorded on the recording medium in a state that the dummy signal whose size is equal to the difference is added to an end of each of the plurality of still image signals. The first management information for individually managing the plurality of still image signals is recorded on the recording medium by the first management information recorder.

The dummy signal is added to each of the plurality of still image signals, and therefore, different image signals are never recorded on the same unit area. When the first management information for individually managing such the still image signals are created, a recording process of the plurality of still image signals is completed.

Addition of the dummy signal enables each still image signal to be recorded on the recording medium in an individually accessible state, and therefore, it is possible to shorten a time required to record the successively photographed still image signals.

In a case a size information recorder records on the recording medium size information indicative of a size of the still image signal in relation to the still image signal, the first management information recorder creates the first management information on the basis of the recorded size information. Thus, even if there is a power-off operation between the recording of the image recorder and the recording of the first management information recorder, the first management information is adequately created.

It is preferable that second management information for managing in a package the plurality of still image signals is recorded on the recording medium by a second management information recorder. In this case, the first management information recorder renews the second management information by the first management information.

It is preferable that the recording medium is a disk recording medium dividedly formed, in a radius direction, with an image signal area for storing image signals and a management information area for storing management information of the image signals. Although there occurs a problem such as head seek in such a recording medium, the number of times of the head seeks is decreased in the present invention.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is a block diagram showing one example of a mapping state of an SDRAM;

FIG. 3 is an illustrative view showing structure of a recording surface of a magneto optical disk;

FIG. 4 is an illustrative view showing one example of an instruction list;

FIG. 5 is an illustrative view showing one example of a hierarchical structure of a directory;

FIG. 6 is an illustrative view showing one example of a connection file;

FIG. 7 is an illustrative view showing one example of the instruction list;

FIG. 8 is a flowchart showing a part of an operation of a CPU in performing a successive photographing process;

FIG. 9 is a flowchart showing another part of the operation of the CPU in performing the successive photographing process;

FIG. 10 is a flowchart showing the other part of the operation of the CPU in performing the successive photographing process;

FIG. 11 is a flowchart showing a further part of the operation of the CPU in performing the successive photographing process;

FIG. 12 is a flowchart showing an operation of the CPU in performing a connection file recording process;

FIG. 13 is a flowchart showing a part of an operation of the CPU in performing a file dividing process; and

FIG. 14 is a flowchart showing another part of the operation of the CPU in performing the file dividing process.

### DETAILED DESCRIPTION OF THE PREFERRED EMBODIMENTS

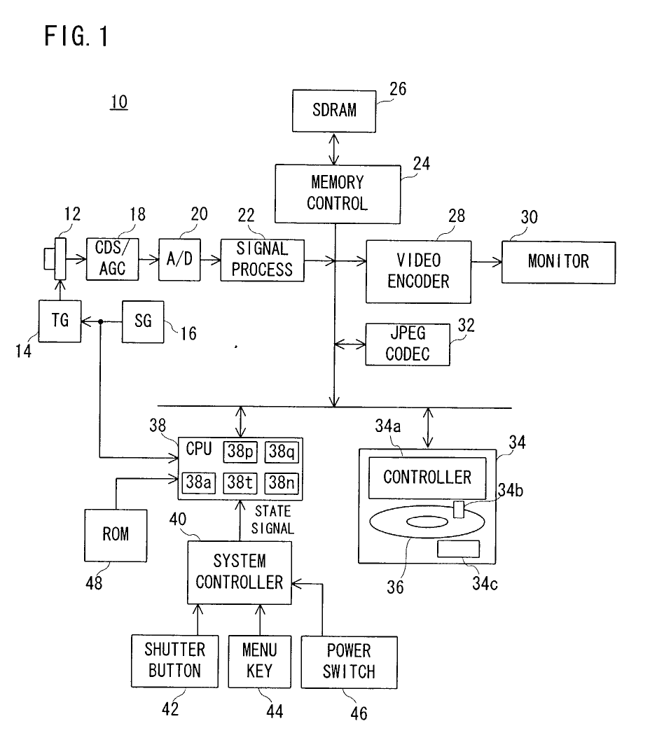

Referring to FIG. 1, a digital camera 10 of this embodiment includes an image sensor 12. The image sensor 12 has on its front surface a color filter (not shown), and an optical image of an object is irradiated onto the image sensor 12 through the color filter.

When a power switch 46 is turned on, a system controller 40 supplies a buttery power (not shown) to a whole system and applies a corresponding state signal into a CPU 38. The CPU 38 instructs a TG (Timing Generator) 14 to photograph the object at 15 fps, for example and applies a predetermined processing instruction to a signal processing circuit 22 and a video encoder 28.

The TG 14 generates a timing signal on the basis of a vertical synchronization signal and a horizontal synchronization signal output from an SG (Signal Generator) 16 and drives the image sensor 12 in a raster scan manner. A camera signal (electric charge) is output from the image sensor 12 every 1/15 seconds, and the output camera signal is input to the signal processing circuit 22 as camera data being a digital signal via a CDS/AGC circuit 18 and an A/D converter 20.

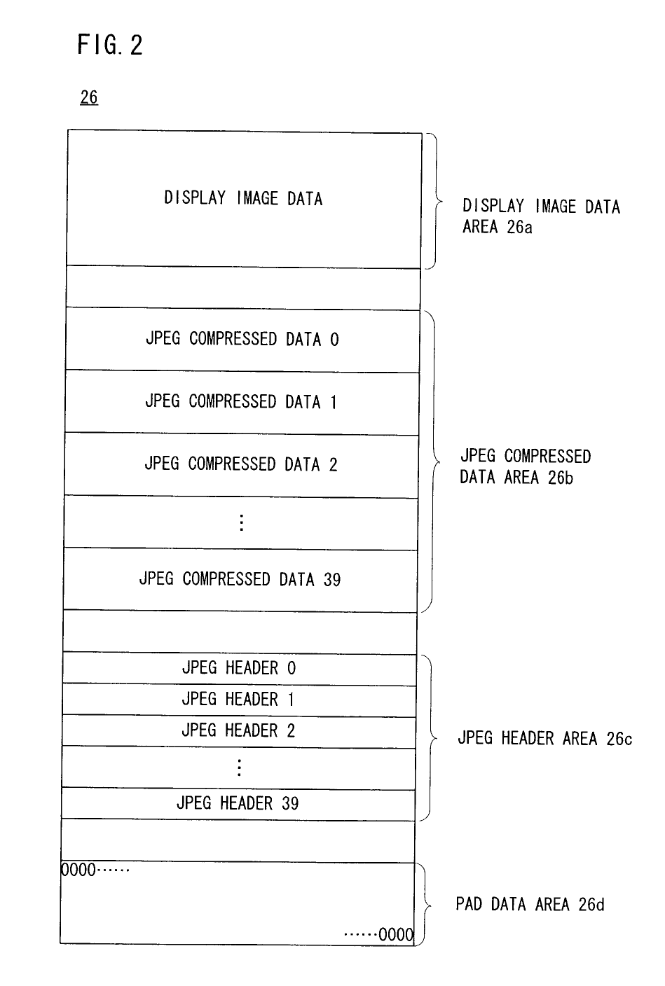

The signal processing circuit 22 performs color separation, white balance adjustment, YUV conversion and etc. on input camera data so as to produce YUV data (display image data) and applies the produced display image data to a memory control circuit 24. The display image data is written to a display image data area 26a shown in FIG. 2 which is formed in an SDRAM 26 by the memory control circuit 24.

The video encoder 28 reads the display image data from the display image data area 26a through the memory control circuit 24 and encodes the read display image data into a composite image signal. The encoded composite image signal is applied to a monitor 30 and therefore, a real time motion image (through image) of the object is displayed on the monitor 30.

When a successive photographing mode (successive shooting mode) is selected by a menu key 44, and a shutter button 42 is operated in a state that the number of times M of successive photographing is set to forty, for example, a state signal indicative of execution of a successive photographing operation is applied from the system controller 40 to the CPU 38. The CPU 38 adjusts a photographing condition such as an amount of exposure, white balance and etc. and then, instructs the TG 14 to perform exposure forty times. The TG 14 performs a total of forty times of the exposures every 1/15 seconds and reads a camera signal obtained by each of the exposures from the image sensor 12. The read camera signal of each frame is converted into the display image data as described above, and the converted display image data is stored in the display image data area 26a by the memory control circuit 24.

The CPU 38 applies a compression instruction to a JPEG codec 32 every time one frame of image signal is read from the image sensor 12. The JPEG codec 32 reads the display image data from the display image data area 26a through the memory control circuit 24 so as to perform JPEG compression on the read display image data. Compressed image data (JPEG compressed data) generated by the JPEG codce 32 is written to a JPEG compressed data area 26b of the SDRAM 26 by the memory control circuit 24.

The CPU 38 furthermore, every time one frame of JPEG compression is performed, voluntarily creates a JPEG header. The created JPEG header is applied to the SDRAM 26 through the memory control circuit 24 and written to a JPEG header area 26c shown in FIG. 2. It is noted that the JPEG header includes information indicative of a shutter speed and an amount of aperture at a time of photographing, resolution of a photographed image, a Q factor related to a compression ratio of the JPEG compression and a JPEG data size, and a thumbnail image obtained by reducing and compressing the display image data, and etc.

After completion of forty times of exposure processing, forty times of compression processing and forty times of JPEG header creating processing, the SDRAM 26 is mapped with the JPEG compressed data 0 to 39 and the JPEG headers 0 to 39 as shown in FIG. 2. It is noted that a process from starting exposure of the image sensor 12 in response to a successive photographing operation to reserving M frames of the JPEG compressed data and the JPEG headers in the SDRAM 26 is defined as a successive photographing process.

The CPU 38 is installed with a real time OS such as μITRON, and a connection file recording process for recording on the magneto optical disk 36 a connection file including the JPEG compressed data 0 to 39, the JPEG headers 0 to 39 and pad data 0 to 39 described below is performed in parallel with the successive photographing process. That is, the successive photographing process is executed by one task, and the connection file recording process is executed by another task.

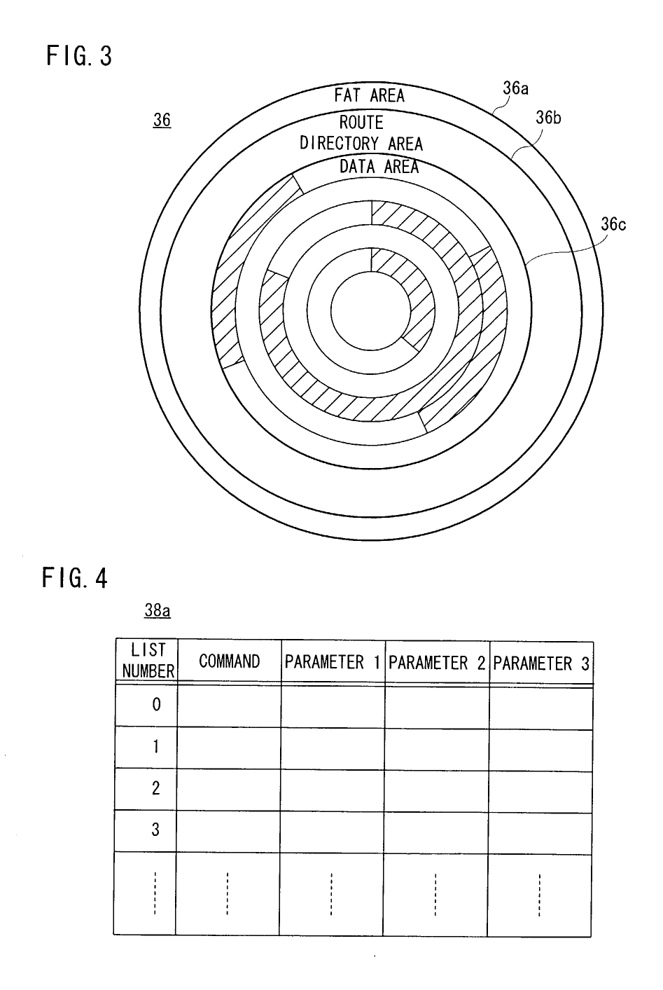

The magneto optical disk 36 is a detachable and nonvolatile disk recording medium and formed with an FAT (File Allocation Table) area 36a, a route directory area 36b and a data area 36c on its recording surface as shown in FIG. 3. The data area 36c is distributed with a plurality of vacant clusters (cluster: unit area) in a spread manner, the FAT area 36a is written with FAT information indicative of a link state of written clusters. Furthermore, the route directory area 36b is written with a directory entry.

The CPU 38 outputs a predetermined access request to a disk drive 34 in the connection file recording process. The disk controller 34a gains an access to the magneto optical disk 36 in a manner according to the access request by controlling a magnetic head 34b and an optical pickup 34c. Herein, the CPU 38 utilizes an instruction list 38a shown in FIG. 4 so as to smoothly execute the successive photographing process and the connection file recording process.

When the shutter button 42 is depressed, the CPU 38 sets in the instruction list 38a commands and parameters respectively corresponding to “start of recording process” “folder creation” “file creation” and “file open”. Setting of “start of recording process” starts the connection file recording process. Furthermore, setting of “folder creation” newly creates a successive photographing-use folder on the data area 36c shown in FIG. 3, and setting of “file creation” creates a connection file hierarchically below the newly successive photographing-use folder. In addition, setting of “file open” creates a handle number for specifying the newly connection file.

In “folder creation”, a folder name of the successive photographing-use folder and size information indicative of “0” are written to the data area 36c, FAT information of the FAT area 36a is renewed, and size information (exists in the route directory area 36b) of a subdirectory to which the successive photographing-use folder belongs is renewed. Furthermore, in “file creation”, the file name of the connection file and the size information indicative of “0” are written to the data area 36c, the FAT information of the FAT area 36a is renewed, and the size information of the subdirectory to which the connection file belongs is renewed.

Furthermore, every time one frame of the JPEG compressed data and the JPEG headers are stored in the SDRAM 26, “file writing” for the JPEG header, “file writing” for the JPEG compressed data and “file writing” for the pad data are set in the instruction list 38a. Each of “file writing” has a handle number of the connection file as the parameter. It is noted that data formed by the JPEG header and the JPEG compressed data is defined as “JPEG data”.

The pad data is data added for the purpose of conforming a head address of the JPEG data of each frame to a head address of each of the cluster. Since the JPEG data size can be different depending on frames, a pad data size is acquired by subtracting from the cluster size a remainder which is obtained by dividing the JPEG data size of each frame by a cluster size. As shown in FIG. 2, the SDRAM 26 is formed with a pad data area 26d from which pad data with a calculated size is read.

The forty frames of the JPEG headers, JPEG compressed data and pad data are produced, and therefore, a total of 120 of “file writing” is set in the instruction list 38a. After completion of setting 120 of “file writing”, file size information indicative of the JPEG data size of each frame and the number of frames “40” are created so as to be stored in the SDRAM 26, and then, “file writing” for the file size information is set in the instruction list 38a.

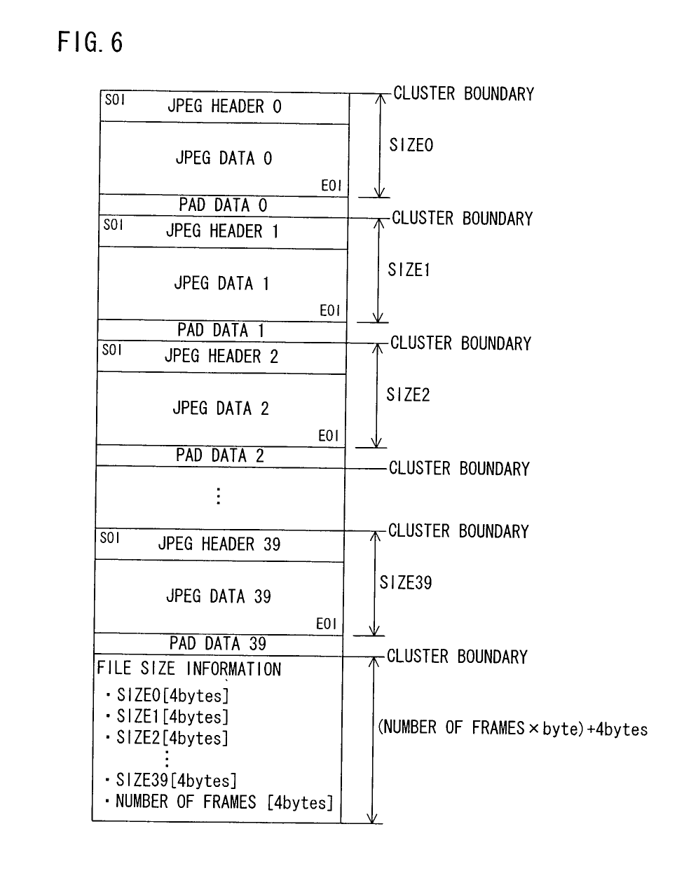

As a result of executing “file writing” thus set, 40 frames of the JPEG headers, the JPEG compressed data, and the pad data, and the file size information are accumulated in the connection file, and therefore, a connection file shown in FIG. 6 is obtained. According to FIG. 6, a top of the JPEG header of each frame is adjacent to a boundary of two clusters. Furthermore, each of a size value and the number of frames included in the file size information are represented by 4 bytes.

After completion of creating the connection file, “file close” and “end of recording process” are set in the instruction list 38a. By executing “file close”, the FAT information stored in the FAT area 36a, the size information of the connection file stored in the data area 36c and the size information of the subdirectory at the upper hierarchy stored in the route directory area 36b are renewed. That is, the FAT information is renewed such that a link is formed on a writing area (cluster) of the currently created connection file, and the size information of the connection file and the size information of the subdirectory to which the connection file belongs are renewed. The connection file recording process is completed by “end of recording processing”.

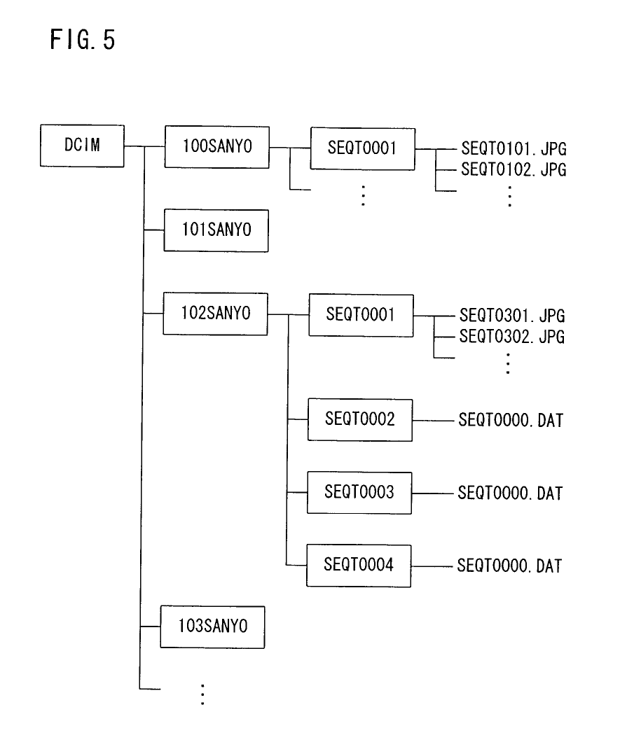

The data area 36c of the magneto optical disk 36 has directory structure shown in FIG. 5. A plurality of subdirectories “* * * SANYO” ( * * * :a directory number of three-digits beginning from 100) are formed hierarchically below a route directory “DCIM”. A successive photographing-use folder “SEQ X X X X ” (X X X X: a folder number of four-digits beginning form 0001) is created hierarchically below an arbitrary subdirectory. The successive photographing-use folder is newly created hierarchically below the currently selected subdirectory, and the connection file is created hierarchically below the successive photographing-use folder. The newly created successive photographing-use folder is assigned with a folder number succeeding to that of a latest successive photographing-use folder belonging to the same subdirectory. On the other hand, a file name of the connection file is “SEQT0000.DAT” at all times.

Accordingly, if a subdirectory selected at a time of successive photographing is “102SANYO”, and a latest successive photographing-use folder existing hierarchically below the subdirectory is “SEQ0003”, a successive photographing-use folder “SEQ0004” is newly created in response to an successive photographing operation, and a connection file “SEQT0000.DAT” is created hierarchically below the successive photographing-use folder.

According to FIG. 5, the connection files “SEQT0000.DATs” are respectively stored in the successive photographing-use folders “SEQ0002”, “SEQ0003” and “SEQ0004” created hierarchically below the subdirectory “102SANYO”. Furthermore, a plurality of image files “SEQ0101.JPG” “SEQ102.JPG” ● ● ● are stored in a successive photographing-use folder “SEQ0001” created hierarchically below a subdirectory “100SANYO”, and a plurality of image files “SEQ0301.JPG” and “SEQ0302.JPG” ● ● ● are stored in a successive photographing-use folder “SEQ0001” created hierarchically below the subdirectory “102SANYO”. This means that although a dividing process of the connection file stored in the successive photographing-use folder “SEQ0001” hierarchically below the subdirectory “100SANYO” or “102SANYO” is completed, a dividing process of the connection file stored in the successive photographing-use folders “SEQ0002”, “SEQ0003” and “SEQ0004” hierarchically below the subdirectory “102SANYO” has not yet completed.

The file dividing process is executed by the CPU 38 in response to an operation of the menu key 44 by an operator. At this time, the instruction list 38a is not utilized. First, a latest successive photographing-use folder is detected from among currently selected subdirectory, and a connection file stored in the detected successive photographing-use folder is opened. Succeedingly, the size information of the JPEG data of each frame and the number of frames are detected from the file size information included in the connection file. After completion of detecting the size information and the number of frames, the file name and the size information of the connection file are deleted from the data area 36c. Then, the file name and the size information of each JPEG data are written to the data area 36b, and the FAT information on the FAT area 36a is renewed such that a link is formed on the file names and the size information. Thus, the connection file is converted to a plurality of image files. Furthermore, a size of the subdirectory at the upper hierarchy is changed due to such a file conversion, and therefore, size information of the subdirectory stored in the route directory area 36b is also renewed.

Thus, when the successive photographing operation is performed, the connection file is created at the data area 36c on the magneto optical disk 36, and the FAT information on the FAT area 36a and the size information on the route directory area 36b are renewed. When the connection file is divided into a plurality of image files, the file name and the size information stored in the data area 36c are renewed in a package, and then, the FAT information on the FAT area 36a is renewed. Thereafter, the size information of the route directory area 36b is renewed. Thus, the number of times of head seeks is decreased and therefore, it is possible to shorten a time required to record successively photographed image files. That is, it is possible to improve responsivity of the successive photographing operation.

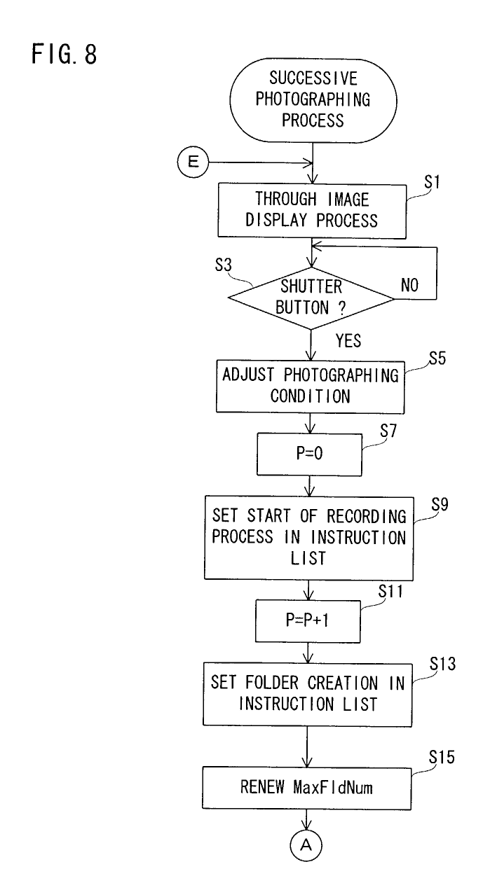

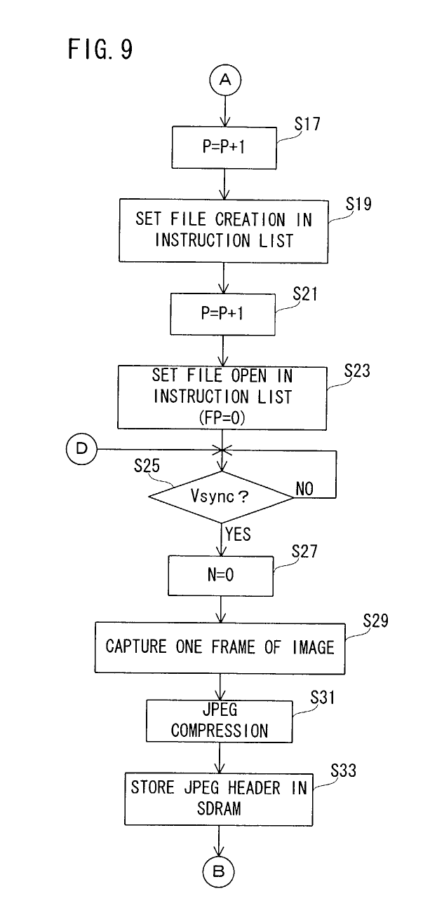

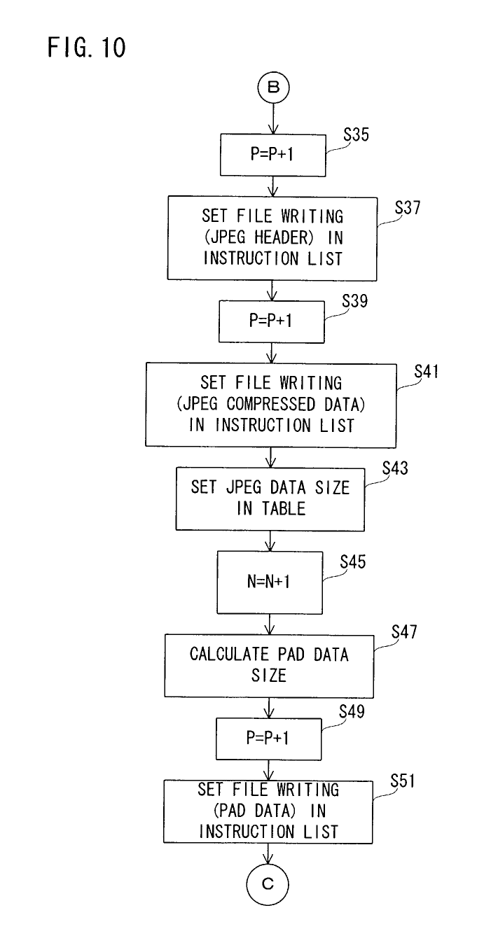

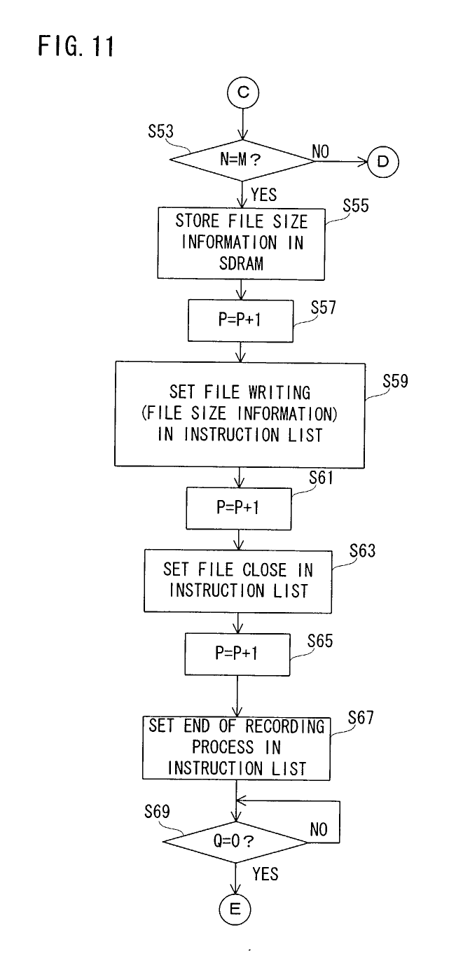

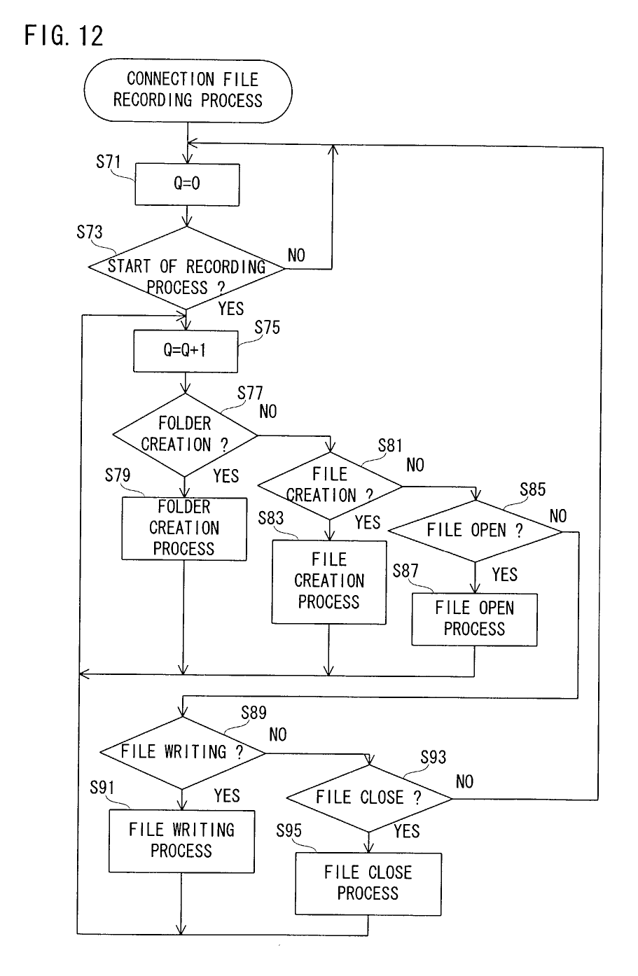

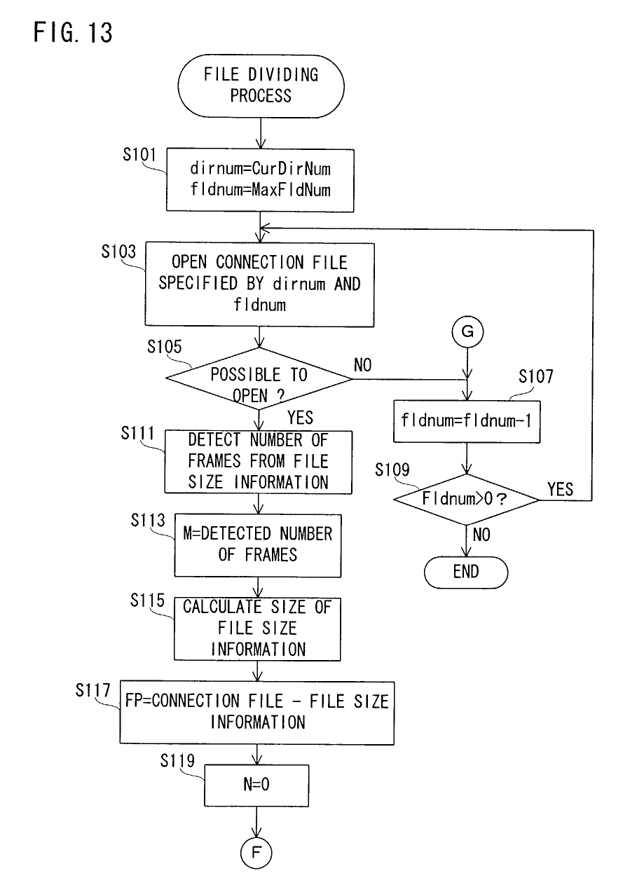

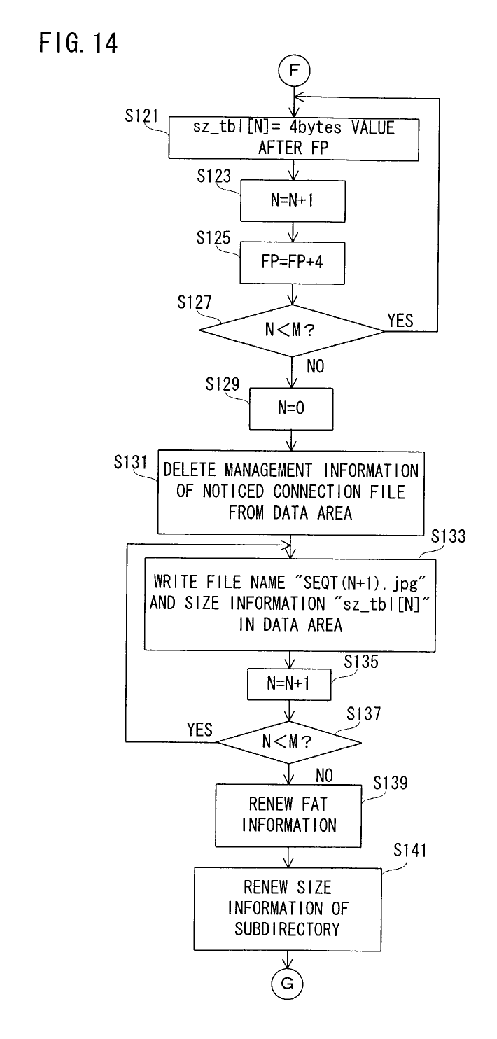

The CPU 38 specifically processes flowcharts shown in FIG. 8 to FIG. 14. FIG. 8 to FIG. 11 show a task of the successive photographing process, FIG. 12 shows a task for the connection file recording process, and FIG. 13 and FIG. 14 show a task for the file dividing process. It is noted that a program corresponding to these flowcharts are stored in a ROM 48.

First, referring to FIG. 8, a through image display process is performed in a step S1. More specifically, a photographing instruction is applied to the TG 14, and a processing instruction is applied to the signal processing circuit 22 and the video encoder 28. Therefore, a through image is displayed on the monitor 30. It is determined whether or not the shutter button 42 is operated in a step S3, and if “YES” is determined, a photographing condition such as a shutter speed, an amount of aperture, white balance and etc. are adjusted in a step S5.

A count value P of a counter 38p is reset in a step S7, and “start of recording process” is set in the instruction list 38a in a following step S9. The count value P is incremented in a step S11, and “folder creation” is set in the instruction list 38a in a step S13. A folder number of a successive photographing-use folder newly created by “folder creation” is set as a maximum folder number MasFldNum in a step S15. The count value P is incremented in a step S17, and “file creation” is set in the instruction list 38a in a step S19. The count value P is incremented in a step S21, and “file open” is set in the instruction list 38a in a step S23.

The count value P is corresponding to a list number of the instruction list 38a shown in FIG. 4. Accordingly, “start of recording process”, “folder creation”, “file creation” and “file open” are respectively set in columns of list numbers “0” to “4”.

TABLE 1

| | | PARA- | PARA- | PARA- |
|---|---|---|---|---|
| | | METER | METER | METER |
| OPERATION | COMMAND | 1 | 2 | 3 |
| START OF | FILE_{—} | — | — | — |
| RECORDING | STRT | | | |
| PROCESS | | | | |
| FOLDER | FOLDER_{—} | DRIVE | FILE PATH | — |
| CREATION | CREATE | NUMBER | | |
| FILE | FILE_{—} | DRIVE | FILE PATH | — |
| CREATION | CREATE | NUMBER | | |
| FILE OPEN | FILE_{—} | DRIVE | FILE PATH | — |
| | OPEN | NUMBER | | |
| FILE | FILE_{—} | HANDLE | SDRAM | SIZE (byte) |
| WRITING | WRITE | NUMBER | ADDRESS | |
| FILE | FILE_{—} | HANDLE | — | — |
| CLOSE | CLOSE | NUMBER | | |
| END OF | FILE_{—} | — | — | — |
| RECORDING | END | | | |
| PROCESS | | | | |

Referring to the table 1, FILE_START is set as the command of “start of recording process”, and FOLDER_CREATE, a drive number and a file path are respectively set as the command and the parameters1 and 2 for “folder creation”. Furthermore, FILE_CREAT, a drive number and a file path are respectively set as the command, and the parameters 1 and 2 for “file creation”, and FILE_OPEN, a drive number and a file path are respectively set as the command, and the parameters 1 and 2 for “file open”. When a subdirectory currently selected is “102SANYO” and a latest successive photographing-use folder created in the subdirectory is “SEQT0003”, a file path set for “folder creation” becomes “¥¥DCIM¥¥102SANYO¥¥SEQT0004”. Thus, a successive photographing-use folder “SEQT0004” is newly created hierarchically below the subdirectory “102SANYO”. For following “file creation”, “¥¥DCIM¥¥102SANYO¥¥SEQT0004¥¥SEQT0000.DAT” is set as the file path, and whereby, a connection file “SEQT0000.DAT” is created hierarchically below the newly created successive photographing-use folder “SEQT0004”. Furthermore, in a case the connection file is opened, the file path set for “file open” becomes “¥¥DCIM¥102SANYO¥¥SEQT0004¥¥SEQT0000.DAT”.

It is determined whether or not a vertical synchronization signal is generated in a step S25, and if “YES” is determined, a count value N of a counter 38n is initialized in a step S27. In a step S29, an exposure instruction is applied to the TG 14, and a processing instruction is applied to the signal processing circuit 22 so as to capture one frame of display image data. The display image data is reserved in the display image data area 26a of the SDRAM 26. A compression instruction is applied to the JPEG codec 32 in a step S31. The JPEG codec 32 reads the display image data from the display image data area 26a and performs JPEG compression on the read display image data. The JPEG compressed data generated by the JPEG compression is stored in the JPEG data area 26b of the SDRAM 26. In the step S33, a JPEG header is created by the CPU 38 and then written to the JPEG header area 26c of the SDRAM 26.

The count value P is incremented in a step S35, and “file writing” for the JPEG header is set to the instruction list 38a in a step S37. The count value P is incremented in a step S39, and “file writing” for the JPEG compressed data is set to the instruction list 38a in a step S41. As can be understood form the table 1, FILE_WRITE, a handle number (obtained by the file open process described later), an SDRAM address and a data size are respectively set as the command and the parameters 1, 2 and 3 for “file writing”. Accordingly, the head address and the data size of the JPEG header stored in the SDRAM 26 in the immediately-preceding step S33 are respectively set to the parameters 2 and 3 in the step S37. Furthermore, the head address and the data size of the JPEG compressed data stored in the SDRAM 26 on the basis of the process in the immediately-preceding step S31 are respectively set to the parameters 2 and 3 in the step S41.

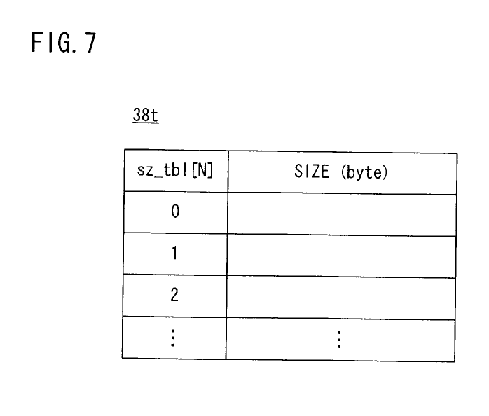

In a step S43, a total size of the JPEG compressed data and JPEG header respectively created in the steps S31 and S33 is acquired, and size information indicative of the total size are set in a index information table 38t shown in FIG. 7. The size information is assigned to the current count value N.

The count value N is incremented in a step S45, and a pad data size is calculated according to an equation 1 in a following step S47.

pad data size=cluster size−(total size % cluster size) [equation 1]

“Total size % cluster size” means a remainder obtained by dividing the total size acquired in the immediately-preceding step S43 by the cluster size. The pad data size is acquired by subtracting such the remainder from the cluster size.

“File writing” for the pad data is set in the instruction list 38a in a step S51. As described above, FILE_WRITE, the handle number, the SDRAM address and the data size are respectively set as the command and parameters 1, 2 and 3 for “file writing”. By the way, the SDRAM 26 is formed with the pad data area 26d as shown in FIG. 2. Accordingly, the head address of the pad data area 26d and the calculated pad data size are respectively set as the parameters 2 and 3 in the step S51.

It is determined whether or not the count value N reaches a numerical value M which is the number of times of the successive photographing in a step S53, and if “NO” is determined, the process returns to the step S25. Thus, a series of processes from the step S27 to S53 is repeated M times. For M=40, the JPEG data 0 to 39 and the JPEG headers 0 to 39 are mapped on the SDRAM 26 as shown in FIG. 2, and a total amount of 120 of “file writing” is set in the instruction list 38a.

When the count value N reaches the numerical value M, the process proceeds from the step S53 to a step S55 so as to write to the SDRAM 26 the file size information of 4×M+4 bytes formed by M frame of the size information set in the index information table 38t and the number of frames “M”. The count value P is incremented in a step S57, and “file writing” for the file size information is set in the instruction list 38a in a step S59. At this time, the head address of the file size information is set as the parameter 2, and “4×M+4 bytes” are set as the parameter 3.

The count value P is incremented in a step S61, and “file close” is set in the instruction list 38a in a succeeding step S63. Furthermore, the count value P is incremented in a step S65, and “end of recording process” is set in the instruction list 38a in a step S67. For “file close”, FILE_CLOSE is set as the command, and the handle number of the file to be closed is set as the parameter 1. FILE_END is set as the command for “end of recording process”.

A count value Q of a counter 38q is determined in a step S69. In the connection file recording process described later, the command assigned to the list number corresponding to the count value Q is executed. The count value Q is incremented every execution of the command and is reset by executing “end of recording process”. Accordingly, Q=0 means that processing of all the commands is completed. If Q=0 is satisfied, “YES” is determined in the step S69, and then, the process is returned to the step S1.

Referring to FIG. 12, in the connection file recording process, the count value Q is reset in a step S71, and it is determined whether or not FILE_START is set to the list number corresponding to the count value Q in a step S73. If “NO” is determined herein, the process returns to the step S71. If “YES” is determined, the count value Q is incremented in a step S75 and then, the command assigned to the list number corresponding to the incremented count value Q is determined in respective steps S77, S81, S85, S89 and S93.

If the set command is FOLDER_CREATE, “YES” is determined in the step S77, and a folder creation process is performed in a step S79. More specifically, the disk drive 34 is specified by a drive number set as the parameter 1, and a successive photographing-use folder creation request on the basis of the file path set as the parameter 2 is applied to the disk drive 34. Furthermore, a successive photographing-use folder is created on the data area 36c of the magneto optical disk 36. That is, the folder name of the successive photographing-use folder and the size information indicative of “0” are written to the data area 36c, the FAT information at the FAT area 36a is renewed, and the size information of the subdirectory to which the successive photographing-use folder belongs is renewed at the route directory area 36b. In the above-described example, the successive photographing-use folder “SEQT0004” is created hierarchically below the subdirectory “102SANYO”. When a READY signal is sent back from the disk drive 34, it is regarded that creation of the successive photographing-use folder is completed and then, the process returns to the step S75.

If the set command is FILE_CREAT, “YES” is determined in a step S81, and a file creation process is performed in a step S83. The disk drive 34 is specified by the drive number set as the parameter 1, and a file creation request on the basis of the file path set as the parameter 2 is applied to the disk drive 34. Therefore, a connection file is created on the data area 36c of the magneto optical disk 36. More specifically, the file name of the connection file and the size information indicative of “0” are written to the data area 36c of the magneto optical disk 36, the FAT information at the FAT area 36a is renewed, and the size information of the subdirectory to which the connection file belongs is renewed at the route directory area 36b. In the above-described example, the connection file “SEQ0000.DAT” is created hierarchically below the successive photographing-use folder “SEQT0004” created hierarchically below the subdirectory “102SANYO”. When the READY signal is sent back from the disk drive 34, it is regarded that creation of the connection file is completed and then, the process returns to the step S75.

When the set command is FILE_OPEN, the process proceeds from the step S85 to a step S87 so as to perform a file open process. That is, the disk drive 34 is specified by the drive number set as the parameter 1, and a connection file open request on the basis of the file path set as the parameter 2 is applied to the disk drive 34. When the ready signal indicative of opening the connection file is sent back from the disk drive 34, the handle number to be assigned to the connection file is created. In the above-described example, the connection file “SEQT0000.DAT” stored in the successive photographing-use folder “SEQT0004” hierarchically below the subdirectory “102SANYO” is specified, and the handle number to be assigned to the connection file is created. The created handle number is utilized for “file writing” in the steps S37, S41, S51 and S59. After completion of the process, the process returns to the step S75.

When the set command is FILE_WRITE, the process proceeds from the step S89 to a step S91 so as to perform a file writing process. More specifically, the connection file to be written is specified by the handle number set in the parameter 1, and data is read from the SDRAM 26 on the basis of the SDRAM address and the data size set in the parameters 2 and 3. Then, the disk drive 34 is required to write the read data to the connection file specified by the handle number. The disk drive 34 creates the FAT information indicative of a link state of the written clusters every time writing of one cluster data is completed. The created FAT information is written to the SDRAM 26 by the CPU 38. After completion of the processing, the process returns to the step S75.

When the set command is FILE_CLOSE, the process proceeds from the step S93 to a step S95 so as to perform a file close process. More specifically, the FAT information at the FAT area 36a is renewed by the FAT information stored in the SDRAM 26, and the size information at the route directory area 36b is renewed with change of the file size. After completion of the processing, the process returns to the step S75.

If the set command is FILE_END, “NO” is determined in the step S93, and the process returns to the step S71. Therefore, the count value Q is reset, and the connection file recording process shifts to a waiting state.

The file dividing process shown in FIG. 13 is started in response to an operation of the menu key 44 for dividing the file. In a step S101, a directory number CurDirNum which is the number of the subdirectory currently selected is set as a directory number dirnum, and a maximum folder number MaxFldNum determined in the step S15 shown in FIG. 8 is set as a folder number fldnum. A file open request is applied to the disk drive 34 so as to open the connection file specified by the directory number dirnum and the folder number fldnum in a step S103. If dirnum=102 and fldnum=4 are satisfied, the connection file “SEQT0000.DAT” stored in the successive photographing-use folder “SEQT0004” hierarchically below the subdirectory “102SANYO” is requested to be opened.

It is determined whether or not the connection file was actually opened in a step S105. When a NOT READY signal is sent back from the disk drive 34, it is regarded that no connection file specified in the step S103 exists and then, the folder number fldnum is decremented in a step S107, and the renewed folder number fldnum is compared with “0” in a step S109. If fldunm=0 is satisfied, it is determined no connection file exists in the currently selected subdirectory, and the process is ended.

On the other hand, if fldnum>0 is satisfied, it is determined that there is a possibility that the connection file exists in the currently selected subdirectory, and the process returns to the step S103. Accordingly, the processing of the steps S103 to S109 is repeated until the connection file is found or the folder number fldnum becomes “0”.

When the READY signal is sent back from the disk drive 34, it is determined that the connection file was opened, and the process proceeds to a step S111 and the subsequent. The number of frames is detected from the file size information included in the opened connection file in the step S111, and the detected number of frames is set as M in a step S113. A size (=4×M+4 bytes) of the file size information is calculated on the basis of the detected number of frames M in a step S115, and then, a file pointer FP is set to the head address of the file size information on the basis of the calculated size in a step S117.

The counter 38n is initialized in a step S119, and a 4 bytes value starts from an address specified by the file pointer FP is set in the index information table 38t shown in FIG. 7 in a step S121. The 4 bytes value indicates the size of the JPEG data N and is set in the index information table 38t with being assigned to the count value N.

The count value N is incremented in a step S123, and a pointing destination of the file pointer FP is advanced by 4 bytes in a step S125. The count value N is compared with the number of frames M in a step S127, and as long as N<M is satisfied, the processing from the steps S121 to S127 is repeated. Consequently, the size value of the JPEG data of each frame is accumulated in the index information table 38t. For N=M, “YES” is determined in the step S127, and the count value N is initialized in a step S129. Then, the file name and the size information of the noticed connection file are deleted from the data area 36c in a step S131.

The file name “SEQ(N+1).jpg” and the size information “sz_tbl [N]” are written to the data area 36c in a step S133. The count value N is incremented in a step S135, and the count value N is compared with the number of frames M in a step S137. Then, for N<M, the processing from the steps S133 to S137 is repeated while for N=M, the FAT information is renewed in a step S139. More specifically, the FAT information in the FAT area 36a is renewed such that the file name “SEQ(N+1).jpg” and the size information “sz_tbl [N]” are assigned to the JPEG data N. Thus, M of image files in which M frames of the JPEG data are respectively stored are obtained. After completion of the process in the step S139, the size information (exists in the route directory area 36b) of the subdirectory at the upper hierarchy is renewed in a step S141 and then, the process shifts to the step S107.

It is noted that although the FAT system is adopted as a file management system in this embodiment, a UDF (Universal Disc Format) system may alternatively be adopted. In addition, although the pad data is added to the end of the JPEG data of each frame in this embodiment, the pad data may be added to the top of the JPEG data. Also at this time, the JPEG data in different frames is never recorded on the same cluster, and therefore, it is possible to individually manage the JPEG data of each frame.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image recording apparatus for recording a plurality of still image signals on a plurality of unit areas which are formed on a recording medium and each of which has a predetermined size, comprising:
a calculator for calculating as to each of the plurality of still image signals a difference between the predetermined size and a remainder obtained by dividing a signal size by the predetermined size;
an image recorder for recording the plurality of still image signals on said recording medium in a state a dummy signal whose size is equal to the difference is added to an end of each of the plurality of still image signals; and
a first management information recorder for recording on said recording medium first management information for individually managing the plurality of still image signals.

2. An image recording apparatus according to claim 1, further comprising: a size information recorder for recording on said recording medium size information indicative of each size of the plurality of still image signals in relation to the plurality of still image signals, wherein said first management information recorder includes a management information creator for creating the first management information on the basis of the size information recorded on said recording medium.

3. An image recording apparatus according to claim 1, further comprising a second management information recorder for recording on said recording medium second management information to manage in a package the plurality of still image signals, wherein said first management information recorder includes a management information renewer for renewing the second management information by the first management information.

4. An image recording apparatus according to claim 1, wherein said recording medium is a disk recording medium dividedly formed, in a radius direction, with an image area for storing an image signal and a management area for storing at least a part of management information of the image signal.

5. An image recording apparatus according to claim 4, wherein said management area is stored with link information indicative of a link state of unit areas recorded with the image signal.

6. An image signal recording method for recording a plurality of still image signals on a plurality of unit areas which are formed on a recording medium and each of which has a predetermined size, comprising steps of:
(a) calculating as to each of the plurality of still image signals a difference between the predetermined size and a remainder obtained by dividing a signal size by the predetermined size;
(b) recording the plurality of still image signals on said recording medium in a state a dummy signal whose size is equal to the difference is added to an end of each of the plurality of still image signals; and
(c) recording on said recording medium first management information for individually managing the plurality of still image signals.
